(19) United States
(12) Patent Application Publication
(10) Pub. No.: US 2026/0108430 A1
(43) Pub. Date: Apr. 23, 2026

(54) INFANT PACIFIER

(71) Applicant: Patrice E. Gray, Millersburg, OH (US)

(72) Inventor: Patrice E. Gray, Millersburg, OH (US)

(21) Appl. No.: 19/428,633

(22) Filed: Dec. 22, 2025

Related U.S. Application Data
(63) Continuation-in-part of application No. 18/413,672, filed on Jan. 16, 2024.

(51) Int. Cl. A61J 17/00

(52) U.S. Cl. CPC A61J 17/001; A61J 17/111

(57) ABSTRACT

A pacifier device includes a contoured mouth portion, a base guard, and a handle. The contoured mouth portion has a nipple tip and a nipple base configured to engage the oral cavity of an infant and permit airflow through one or more vent holes. The base guard is positioned outside the mouth during use and provides a stable interface with the infant's face. A handle is connected to the base guard for manipulating and securing the device. In certain embodiments, the components are integrally formed.

### CROSS-REFERENCE TO RELATED APPLICATIONS

This application is a continuation-in-part of U.S. patent application Ser. No. 18/413,672, filed Jan. 16, 2024, the disclosure of which is incorporated by reference herein in its entirety.

### STATEMENT REGARDING FEDERALLY SPONSORED RESEARCH OR DEVELOPMENT (IF APPLICABLE)

N/A

### FIELD OF THE DISCLOSURE

This disclosure relates to products and devices designed for oral administration, more particularly products configured to engage the oral cavity of infants or small children. The present disclosure provides improved baby products in the form of pacifiers, comforters, and teats or nipples for use with baby bottles.

### BACKGROUND

The benefits of breastfeeding for an infant and mother are well established, and the use of pacifiers and infant comforting/suckling devices is generally known in the art. Pacifiers, commonly known as soothers or comforters, are widely used devices designed to satisfy the natural sucking reflex of infants and young children. This reflex is present from birth and plays a crucial role in both breastfeeding and self-soothing behaviors. In addition, pacifiers and similar devices are generally employed to soothe distressed infants during periods of discomfort or during periods where they require additional suckling, particularly during the breastfeeding stages. Pacifiers serve not only as a source of comfort for infants but also play a role in supporting oral development during early childhood. Traditional pacifiers and similar devices have been designed to engage the oral cavity of infants and young children, yet traditional pacifiers often fail to accommodate the natural oral structure of an infant's mouth and are typically designed with poor adaptive configuration. Such deficiencies in the prior art can lead to potential health concerns including, but not limited to, teeth misalignment, palate deformation, and weakened tongue muscles in infants.

Accordingly, there remains a need in the field of pacifiers and infant comforting and suckling devices for improved designs that more closely mimic the natural contours of an infant's mouth while providing a secure fit and enhanced comfort. It is desirable to provide a product or device which better accommodates the anatomical structure of the infant oral cavity, promotes healthy oral development, and enhances safety and comfort, while also accomplishing the goals of soothing distressed infants (e.g., reducing crying and fussiness) and supplementing the natural nursing routines of new mothers.

### BRIEF SUMMARY

The present disclosure generally provides a device designed for oral administration. This device is specially designed to engage the oral cavity of an infant or small child during use. Advantageously, the products and devices of the present disclosure are designed to mimic the natural contours of an infant's mouth considering the palate, tongue, and teeth alignment of an infant or small child, for example, to support oral development of the child's mouth and to provide superior fit and enhanced comfort.

Accordingly, in one aspect, the disclosure provides a pacifier device including a contoured mouth portion configured to engage the oral cavity of an infant and support oral development of the infant's mouth, a base guard attached to the contoured mouth portion and configure to ensure secure use and prevent choking, and a handle attached to the base guard. In some embodiments, the contoured mouth portion is designed to fit comfortably against the infant's face. In certain embodiments, the contoured mouth portion is ergonomically designed to mimic the natural contours of the infant's mouth.

In some aspects of the disclosure, the contoured mouth portion can include a nipple base being positioned proximate to the base guard and a nipple tip positioned proximate the nipple base. In some embodiments, the contoured mouth portion can include a plurality of air vent holes integrated into the nipple base. The size and positioning of these air vent holes may vary. For example, in some embodiments, the plurality of air vent holes each can have a diameter of about 5 mm. In some embodiments, the plurality of air vent holes can be positioned approximately 5 mm from the base guard.

The design and shaping of the contour mouth portion may vary in size and dimensions according to the present disclosure. For example, in some embodiments, the nipple base may have a continuous inward curvature extending from the base guard to a proximal end of the nipple tip. In some embodiments, the nipple tip can extend horizontally about 2 cm from its proximal end to a distal end thereof. In certain embodiments, the nipple base may have a maximum interior diameter of about 5 cm. In some embodiments, a top side of the nipple tip can have a vertical height of about 1 cm to about 1.5 cm relative to a horizontal plane bisecting the pacifier device, wherein the top side of the nipple tip can be configured to engage an infant's palate during use. In certain embodiments, a bottom side of the nipple tip may be configured to lay substantially flat against an infant's tongue during use to provide comfort to the infant during use.

Generally, the contoured mouth portion is substantially made of silicone. For example, in some embodiments, the contoured mouth portion may be formed entirely of medical grade silicone. In some aspects of the disclosure, the base guard is designed to ensure a secure fit to the infant's face and to prevent the infant or child from choking on the pacifier device. In certain embodiments, the base guard can be substantially circular and have a diameter of about 6 cm to about 7 cm. In further embodiments, the base guard may include a plurality of raised protrusions positioned along a top surface of the base guard adjacent to a peripheral edge thereof. In such embodiments, the plurality of raised protrusions can each have a height of about 2 mm.

In some aspects of the disclosure, the pacifier device may also include a handle for ease of use. For example, in some embodiments, the handle is configured to curve ergonomically to facilitate grasping and manipulation of the pacifier device. In some embodiments, the handle is formed with a continuous curvature along a longitudinal axis, the curved portion extending about 6 cm to about 10 cm in length. In certain embodiments, the handle can have a width of about 1 cm to about 2 cm. In still further embodiments, the handle can include a plurality of striped indentations integrally molded therein to improve grip and handling during use.

### BRIEF DESCRIPTION OF THE DRAWINGS

FIG. 1 illustrates a two-dimensional side view of an embodiment of a pacifier device.

FIG. 2 illustrates a two-dimensional top view of an embodiment of a pacifier device.

FIG. 3 illustrates a two-dimensional bottom view of an embodiment of a pacifier device.

FIG. 4 illustrates a side perspective view of an embodiment of a pacifier device.

FIG. 5 illustrates a two-dimensional side view of an embodiment of a pacifier device.

FIG. 6 illustrates a two-dimensional rear view of an embodiment of a pacifier device.

FIG. 7 illustrates arear perspective view of an embodiment of a pacifier device.

FIG. 8 illustrates afront perspective view of an embodiment of a pacifier device.

### DETAILED DESCRIPTION

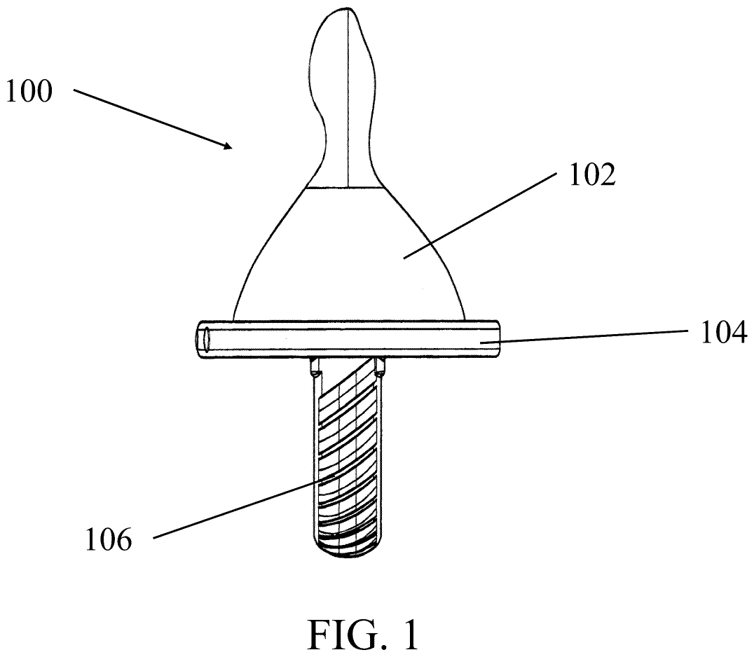

This disclosure relates to a pacifier device designed for oral administration to infants or young children. In some embodiments, the pacifier device comprises a contoured mouth portion, a secure base guard, and an integrated, ergonomic handle. As shown in FIG. 1, for example, the present disclosure provides a pacifier device 100 comprising a contoured mouth portion 102 configured to engage the oral cavity of an infant and support oral development of the infant's mouth, a base guard 104 attached to the contoured mouth portion 102 and configured to ensure secure use and prevent choking, and a handle 106 attached to the base guard 104.

In some embodiments, the contoured mouth portion 102 comprises silicone for comfort and flexibility, including, for example, food-grade silicone, medical-grade silicone, and the like. In certain embodiments, the contoured mouth portion is made entirely of medical-grade silicone. Medical grade silicone is generally manufactured under strict conditions, undergoing extensive biocompatibility testing, e.g., to minimize impurities and contamination and to comply with the highest purity and safety standards. The contoured mouth portion is designed to fit comfortably against the infant's face, and the structure of the contoured mouth portion is ergonomically designed to mimic the natural contours of the infant's mouth.

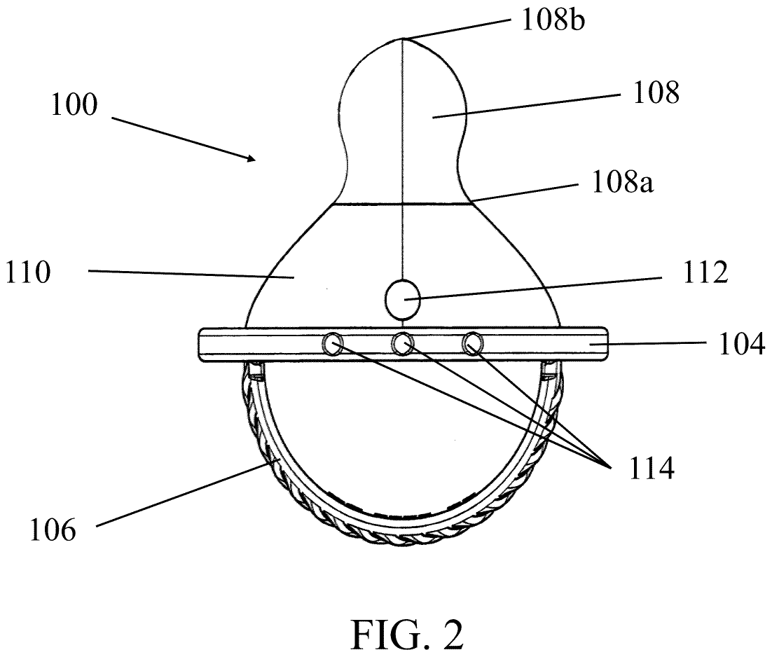

The contoured mouth portion 102 of the pacifier device 100 generally comprises a nipple tip 108 portion and a nipple base 110 portion. Referring to FIG. 2, the nipple tip 108 may include a proximal end 108a and a distal end 108b. In some embodiments, the nipple base 110 has a continuous inward curvature extending from the base guard 104 to the proximal end 108a of the nipple tip 108. This inward curvature allows the nipple base to gradually engage the infant's mouth during use, even when the mouth is wide open, and provides a comfortable and secure fit against the infant's lips. The continued inward curvature produces a gradually declining interior diameter within the nipple base 110, from the base guard 104 to the proximal end 108a of the nipple tip 108. In some embodiments, the nipple base has a maximum interior diameter (i.e., interior diameter of the nipple base proximate the base guard) of about 5 cm. In certain embodiments, the nipple base can have a maximum interior diameter of about 4 cm to about 6 cm, about 4.25 cm to about 5.75 cm, about 4.5 cm to about 5.5 cm, or about 4.75 cm to about 5.25 cm.

In some embodiments, the contoured mouth portion 102 may comprise a plurality of air vent holes 112 integrated into the nipple base 110 to allow for expulsion of air through the device during use. Advantageously, the plurality of air vent holes 112 function as a safety measure for allowing air to flow through the device while also providing adequate and effective suction during use of the pacifier. Typically, the plurality of air vent holes are circular in shape, but the particular shape of the air vent holes is not intended to be limiting thereof. The amount, size, and positioning of the air vent holes may vary. In some embodiments, for example, the contoured mouth portion may comprise at least 1, at least 2, at least 3, at least 4, or more air vent holes integrated into the nipple base. In certain embodiments, the contoured mouth portion may comprise two air vent holes 112 positioned on opposing sides (e.g., top and bottom) of the contoured mouth portion. In some embodiments, each of the air vent holes may have a diameter of about 4 mm to about 6 mm. For example, the air vent holes may have a diameter of about 4 mm to about 6 mm, about 4.25 mm to about 5.75 mm, about 4.5 mm to about 5.5 mm, or about 4.75 to about 5.25 mm. In certain embodiments, each of the air vent holes has a diameter of about 5 mm. In some embodiments, the plurality of air vent holes 112 may be positioned a specified distance from the base guard 104. In some embodiments, for example, each of the plurality of air vent holes may be positioned about 4 mm to about 6 mm, about 4.25 mm to about 5.75 mm, about 4.5 mm to about 5.5 mm, or about 4.75 to about 5.25 mm from the base guard. In certain embodiments, each of the plurality of air vent holes are positioned approximately 5 mm from the edge of the base guard.

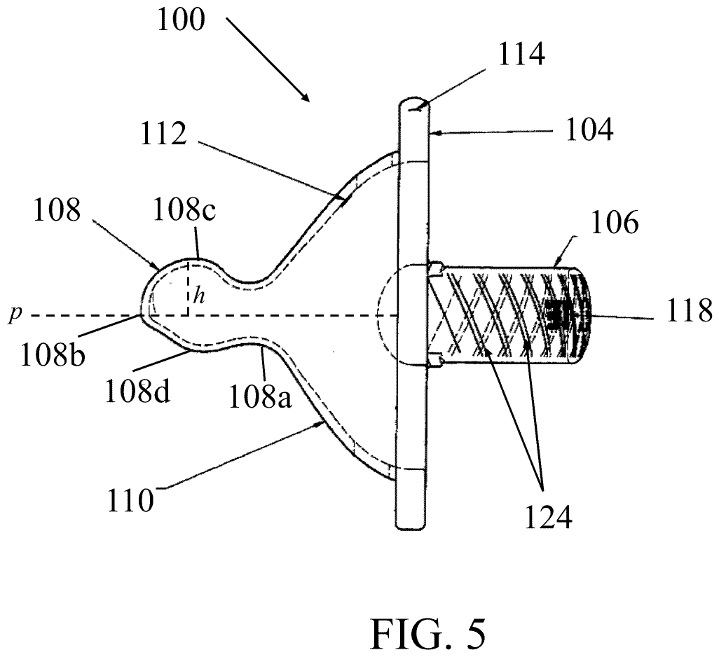

In some aspects of the disclosure, the nipple tip 108 is shaped to ergonomically engage the oral cavity of an infant, thereby facilitating proper oral development and minimizing oral fatigue. For example, the nipple tip is contoured and specifically dimensioned to conform to the anatomical structure of an infant's palate, tongue, and teeth alignment, thereby enhancing comfort and promoting natural sucking behavior. The size and shape of the nipple tip may vary slightly. In some embodiments, the nipple tip 108 extends horizontally about 2 cm from its proximal end 108a to its distal end 108b along a horizontal plane “p” bisecting the pacifier device; e.g., as shown in FIG. 5. In some embodiments, the nipple tip may extend horizontally about 1.8 cm to about 2.2 cm, about 1.85 to about 2.15 cm, about 1.9 cm to about 2.1 cm, about 1.95 to about 2.05 cm, or about 2 cm from its proximal end to its distal end.

Referring to FIG. 5, in some embodiments, the nipple tip 108 comprises a top side 108c and a bottom side 108d which are dimensioned to mimic the natural contours of an infant's mouth, considering palate, tongue, and teeth alignment. In particular, the bottom side 108d of the nipple tip is configured to lay substantially flat against an infant's tongue. Advantageously, this configuration promotes a more comfortable fit in the infant's mouth and prevents potential discomfort caused by pressure being applied to the infant's tongue with conventional pacifier designs in the art that do not lay substantially flat against the infant's tongue. In some embodiments, the top side 108c of the nipple tip is specifically contoured/dimensioned to engage the infant's palate during use to enhance comfort and to promote a natural sucking reflex and healthy oral development. In some embodiments, the top side 108c of the nipple tip has a vertical height “h” of about 1.3 cm relative to a horizontal plane “p” bisecting the pacifier device. In some embodiments, the top side 108c of the nipple tip has a vertical height of about 1 cm to about 1.5 cm, about 1.1 cm to about 1.5 cm, about 1.15 cm to about 1.45 cm, about 1.2 cm to about 1.4 cm, about 1.25 to about 1.35 cm, or about 1.3 cm relative to horizontal plane p.

In some embodiments, the top side 108c of the nipple tip comprises a consistent outward curvature. The space between the top side 108c of the nipple tip and the nipple base 110 comprises an inward curvature. In some embodiments, the space between the distal end 108b of the nipple tip and the bottom side 108d of the nipple tip comprises a flat plane or a slight inward curvature. In some embodiments, the bottom side 108d of the nipple tip comprises an outward curvature. In some embodiments, the proximal end 108a of the nipple tip comprises an inward curvature.

As noted above, the pacifier device 100 described herein further comprises a base guard 104 attached to the contoured mouth portion 102. The base guard is specifically designed to prevent choking, to maintain a secure and comfortable fit against the infant's face and in their oral cavity, and to further support healthy oral development. In some embodiments, the base guard 104 is substantially circular in shape; however, this particular design is not intended to be limiting and base guards of other shapes may be suitable for use. In some embodiments, the base guard 104 is substantially circular shaped and has a diameter of about 6.5 cm. In certain embodiments, the base guard may have a diameter of about 6 cm to about 7 cm, about 6.1 cm to about 6.9 cm, about 6.2 to about 6.8 cm, about 6.3 to about 6.7 cm, or about 6.4 to about 6.6 cm.

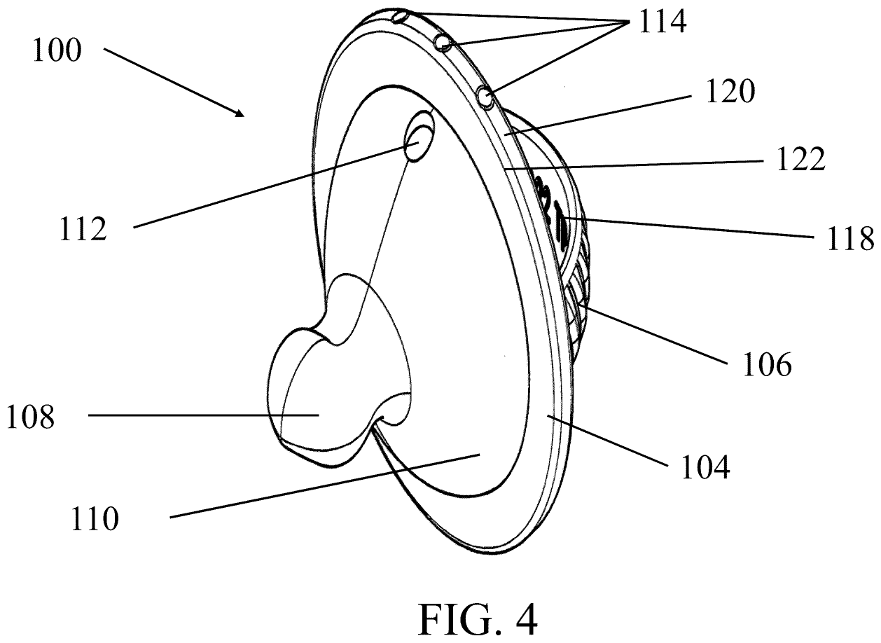

As shown in FIGS. 2, 4, and 6, in some embodiments, the base guard 104 further comprises a plurality of raised protrusions 114. For example, as shown in FIG. 4, in some embodiments the plurality of raised protrusions 114 are positioned along a top surface 120 of the base guard 104 adjacent to a peripheral edge 122 thereof. In some embodiments, the pacifier device comprises three raised protrusions positioned on the top surface of the base guard to facilitate orientation recognition. For example, the raised protrusions are configured to visually distinguish the top side of the pacifier device from the bottom side of the pacifier device. The plurality of raised protrusions may vary in height as desired and each of the raised protrusions may be of the same or different height. Likewise, the plurality of raised protrusions may vary in overall shape or dimension as desired. In some embodiments, the plurality of raised protrusions each have a height of about 2 mm and are substantially circular in shape. In some embodiments, the plurality of raised protrusion may have a height of at least 1 mm, at least 1.5 mm, at least 2 mm, at least 2.5 mm, at least 3 mm, or more. Although the figures provided depict three raised protrusions, the specific number of protrusions is not to be construed as limiting the present disclosure. For example, in some embodiments, the base guard may comprise at least 1, at least 2, at least 3, at least 4, at least 5, or more raised protrusion positioned on the top surface of the base guard.

The peripheral edge 122 of the base guard 104 is designed with sufficient thickness to prevent choking and/or swallowing of the pacifier device while also minimizing the weight of the device. The base guard also imparts structural integrity to the pacifier device. In some embodiments, the peripheral edge 122 of the base guard has a thickness of about 0.9 mm. In certain embodiments, the peripheral edge of the base guard has a thickness of about 0.7 mm to about 1.1 mm, about 0.75 mm to about 1.05 mm, about 0.8 mm to about 1 mm, or about 0.85 mm to about 0.95 mm.

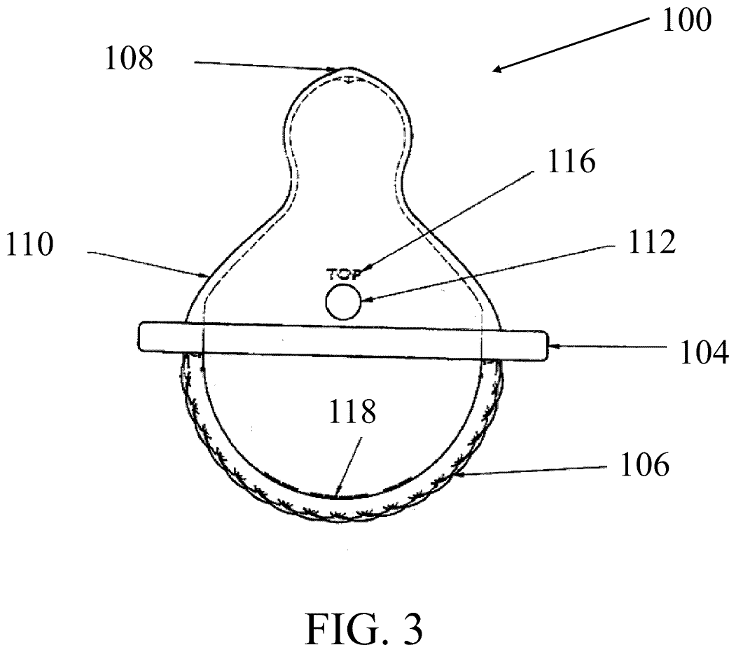

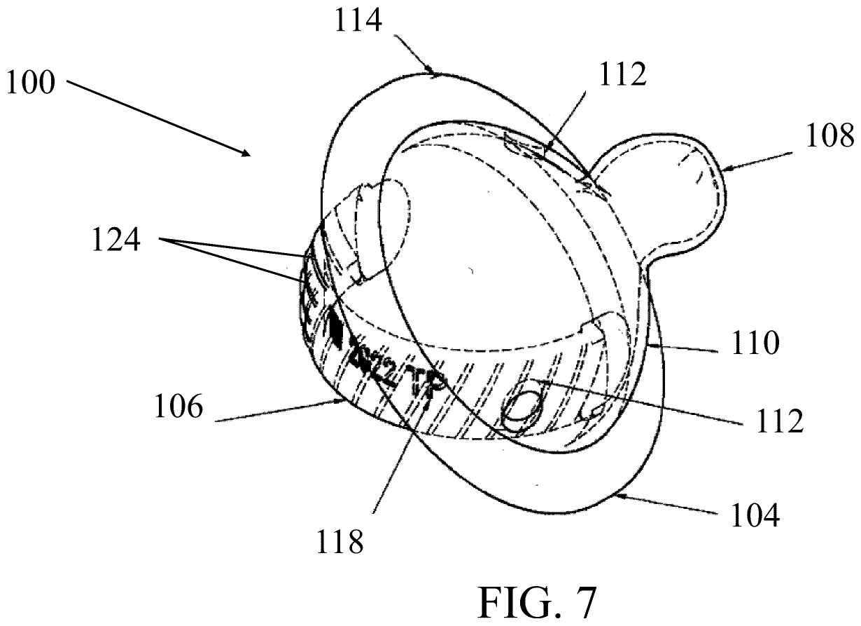

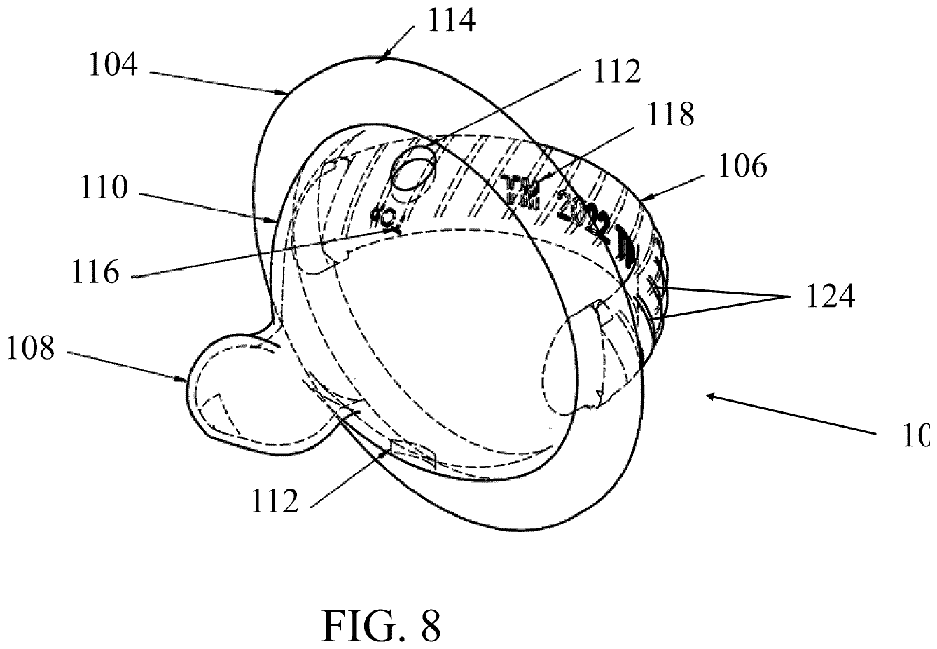

As provided herein, the pacifier device 100 further comprises a handle 106 attached to the base guard 104. In some embodiments, for example as depicted in FIGS. 2-5 and 7-8, the handle may be configured to curve ergonomically to facilitate grasping and manipulation of the pacifier device. In some embodiments, the handle is formed with a continuous curvature along a longitudinal axis (not shown), the curved portion extending about 6 cm to about 10 cm in length. In certain embodiments, the curved portion of the handle may extend about 6 cm to about 10 cm, about 6.5 cm to about 9.5 cm, about 7 cm to about 9 cm, about 7.5 cm to about 8.5 cm, or about 8 cm in length. The width of the handle may vary in certain implementations as desired. In some embodiments, the handle may have a width of about 1 cm to about 2 cm, about 1.1 cm to about 1.9 cm, about 1.2 cm to about 1.8 cm, about 1.3 cm to about 1.7 cm, about 1.4 cm to about 1.6 cm, or about 1.5 cm.

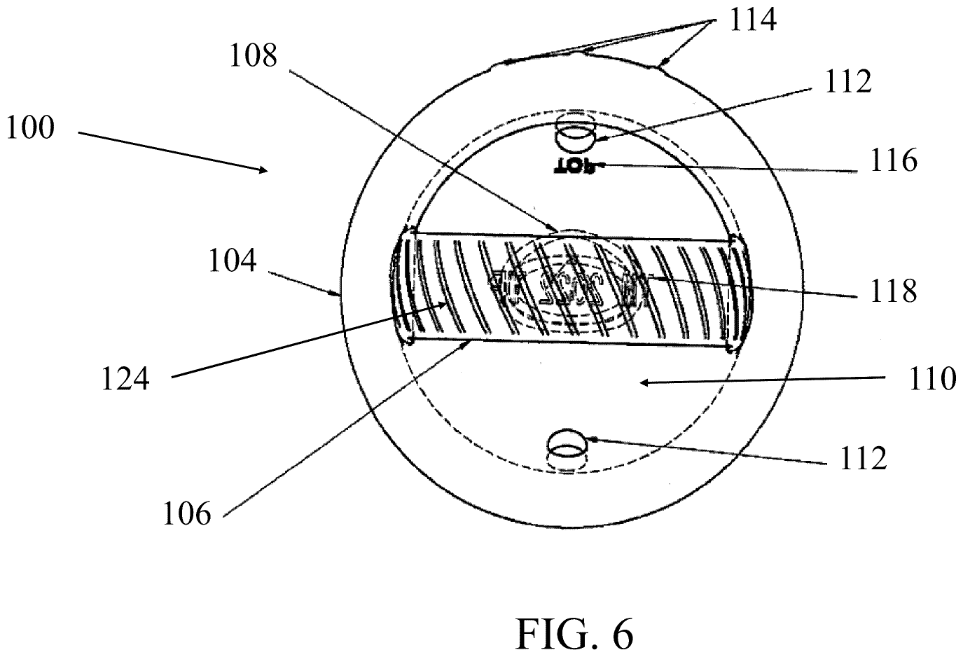

In addition, the handle 106 may comprise one or more grip enhancing surface features including, but not limited to, stripes, recesses, protrusions, grooves, and the like. For example, these grip enhancing surface features may be dimensioned or fabricated to increase frictional resistance and facilitate manual grasping of the handle. As shown in FIGS. 5-8, in some embodiments the handle 106 may include a plurality of striped indentations 124 integrally molded therein to improve grip and handling during use. In some embodiments, these striped indentations may be in the form of a plurality of longitudinally oriented, recessed grooves formed along the underside of the handle surface and configured to enhance tactile engagement and gripping stability. In some embodiments, the striped indentations 124 can be arranged in a crosswise pattern (e.g., as depicted in FIG. 5) or, in other embodiments, the striped indentations 124 may be configured in a parallel arrangement (e.g., as depicted in FIGS. 6-8).

The pacifier devices described herein may optionally also include various other features designed for ease of use, orientation recognition, branding, brand recognition, compliance indicators, and the like. In some embodiments, for example, the pacifier device 100 may comprise directional wording 116 integrated into the contoured mouth portion 102 (e.g., for orientation recognition or ease of use) and/or an identifying mark(s) 118 integrated into the handle 106 (e.g., for branding or compliance purposes).

While the present disclosure focuses on embodiments of pacifier devices in detail, it should be noted that one or more embodiments of the present disclosure may be suitable for use in other types of products or devices. For example, as noted herein above the device provided herein may be in the form of pacifiers, baby comforters, or teats for use with baby bottles and other nursing implements. It is contemplated that one or more elements or components provided herein (e.g., contoured mouth portion, base guard, innovative nipple design, etc.) may be suitable for use in other infant applications, for example, as a topper/nipple for baby bottles, feeders, or other nursing implements configured for oral administration to infants or small children. For example, the unique nipple design described herein can readily be integrated into subsequent designs and adaptations related to nipples for baby bottles and other nursing or teething products commonly used in the industry. Without intending to be bound by theory, it is further noted that the particular benefits associated with the innovative nipple design in pacifier devices described herein (i.e., safety, comfort, healthy oral development, etc.) would readily provide the same benefits to healthy oral development across other applications as described herein.

Many modifications and other embodiments of the disclosure set forth herein will come to mind to one skilled in the art to which these disclosures pertain having the benefit of the teachings presented in the foregoing description. Therefore, it is to be understood that the disclosure is not to be limited to the specific embodiments disclosed and that modifications and other embodiments are intended to be included within the scope of the appended claims.

Although specific terms are employed herein, they are used in a generic and descriptive sense only and not for purposes of limitation.

I claim:

1. A pacifier device comprising:
a contoured mouth portion configured to engage the oral cavity of an infant and support oral development of the infant's mouth;
a base guard attached to the contoured mouth portion and configured to ensure secure use and prevent choking; and
a handle attached to the base guard.

2. The pacifier device of claim 1, wherein the contoured mouth portion is designed to fit comfortably against the infant's face.

3. The pacifier device of claim 1, wherein the contoured mouth portion is ergonomically designed to mimic the natural contours of the infant's mouth.

4. The pacifier device of claim 1, wherein the contoured mouth portion comprises a nipple base positioned proximate to the base guard and a nipple tip positioned proximate to the nipple base.

5. The pacifier device of claim 4, wherein the contoured mouth portion further comprises a plurality of air vent holes integrated into the nipple base.

6. The pacifier device of claim 5, wherein the plurality of air vent holes each have a diameter of about 5 mm.

7. The pacifier device of claim 5, wherein the plurality of air vent holes are positioned approximately 5 mm from the base guard.

8. The pacifier device of claim 4, wherein the nipple base has a continuous inward curvature extending from the base guard to a proximal end of the nipple tip.

9. The pacifier device of claim 8, wherein the nipple tip extends horizontally about 2 cm from its proximal end to a distal end thereof.

10. The pacifier device of claim 8, wherein the nipple base has a maximum interior diameter of about 5 cm.

11. The pacifier device of claim 4, wherein a top side of the nipple tip has a vertical height of about 1 cm to about 1.5 cm relative to a horizontal plane bisecting the pacifier device, the top side of the nipple tip configured to engage an infant's palate during use.

12. The pacifier device of claim 4, wherein a bottom side of the nipple tip is configured to lay substantially flat against an infant's tongue during use.

13. The pacifier device of claim 1, wherein the contoured mouth portion comprises medical grade silicone.

14. The pacifier device of claim 1, wherein the base guard is substantially circular and has a diameter of about 6 cm to about 7 cm.

15. The pacifier device of claim 1, wherein the base guard comprises a plurality of raised protrusions positioned along a top surface of the base guard adjacent to a peripheral edge thereof.

16. The pacifier device of claim 15, wherein the plurality of raised protrusions each have a height of about 2 mm.

17. The pacifier device of claim 1, wherein the handle is configured to curve ergonomically to facilitate grasping and manipulation of the pacifier device.

18. The pacifier device of claim 17, wherein the handle is formed with a continuous curvature along a longitudinal axis, the curved portion extending about 6 cm to about 10 cm in length.

19. The pacifier device of claim 1, wherein the handle has a width of about 1 cm to about 2 cm.

20. The pacifier device of claim 1, wherein the handle comprises a plurality of striped indentations integrally molded therein to improve grip and handling during use.
